(19) United States
(12) Patent Application Publication
(10) Pub. No.: US 2012/0217203 A1
(43) Pub. Date: Aug. 30, 2012

(54) SELF-CONTAINED DIALYSIS SYSTEM

(75) Inventors: Paul Jeffrey Haney, Beloit, WI (US); Brian L. Webb, Roscoe, IL (US); Navid Reza Haghdoost, Rockford, IL (US); Rizwan Farooqui, Arlington Heights, IL (US); Atul Madhukar Deshpande, Rockford, IL (US)

(73) Assignee: Pierce Biotechnology, Inc., Rockford, IL (US)

(21) Appl. No.: 13/345,297

(22) Filed: Jan. 6, 2012

Related U.S. Application Data
(60) Provisional application No. 61/447,484, filed on Feb. 28, 2011.

(51) Int. Cl. B01D 61/24; B01D 61/28

(52) U.S. Cl. 210/644; 210/321.6

(57) ABSTRACT

A dialysis system including a generally sealed vessel configured to receive a buffer, and a dialysis device positioned in the generally sealed vessel. The dialysis device includes an inner member and an outer member trapping a dialysis membrane between the members. The dialysis device is configured to receive a sample to enable dialysis of the sample with respect to the buffer across the membrane.

This application claims the benefit of pending U.S. Provisional Application No. 61/447,484, filed Feb. 28, 2011; the entirety is hereby expressly incorporated by reference herein.

Dialysis systems for enabling the diffusion of small molecules.

### BRIEF DESCRIPTION OF THE DRAWINGS

FIG. 1 is an exploded perspective view of one embodiment of a dialysis device.

FIG. 2 is a side view of the device of FIG. 1, shown in an assembled condition.

FIG. 3 is a side cross section of the device of FIG. 2.

FIG. 4 is an exploded perspective view of the device of FIG. 2, shown in conjunction with a vessel and a cap.

FIG. 5 is a side cross section of the system of FIG. 4, with the dialysis device inserted into the vessel.

FIG. 6 is a side cross section of the system of FIG. 5, with the cap attached.

FIG. 7 is an exploded cross section of another embodiment of the dialysis device.

FIG. 8 is a side cross section of the device of FIG. 7, shown in an assembled condition.

In one embodiment the self-contained dialysis system described includes or utilizes a dialysis device 10, shown in FIGS. 1-3. The dialysis device 10 includes an inner member 12, an outer member 14, and a membrane 16. In the illustrated embodiment, the inner member 12 takes the form of a generally cylindrical sleeve that is open at its upper and lower ends. The inner member 12 includes a radially outwardly-extending flange 18 positioned at or adjacent to the upper end.

One embodiment is a dialysis system that contains a generally sealed device configured to receive both a buffer and a dialysis chamber, where positioning the dialysis chamber seals the device. The device is configured to receive a sample to enable dialysis of the sample with respect to the buffer across the membrane. The dialysis device sealingly engages the system such that buffer is generally fluidly isolated from sample in the dialysis device.

One embodiment is a dialysis method, where buffer is placed in a vessel. The dialysis device is accessed including an inner member and an outer member trapping a dialysis membrane therebetween. A sample is placed in the dialysis device. The dialysis device is placed into the vessel as an integral component of the sealing system, thus sealing the vessel.

The outer member 14 can similarly take the form of a generally cylindrical sleeve that is open at its upper and lower ends, and includes a radially outwardly-extending flange 20 at or adjacent to its upper end. The outer member 14 has a lower portion 14a defined by a relative small radius, and an upper portion 14b defined by a radius larger than that of the lower portion 14a. A generally radially extending lip 22 is positioned between the lower 14a and upper 14b portions. As noted above, the illustrated inner 12 and outer 14 members are both generally cylindrical and thus circular in cross section. However, if desired, the inner 12 and outer 14 members can have a variety of other shapes in cross section, so long as the shapes are generally corresponding, such as triangular, square, hexagonal, octagonal, star shaped, irregularly shaped, or other polygons or shapes. The inner 12 and outer 14 members can be made from any of a wide variety of materials that exhibit a low absorbency of proteins and can survive common sterilization procedures, including but not limited to polypropylene.

In the illustrated embodiment the membrane 16 is generally flat and circular, although the membrane 16 can take any of a wide variety of shapes and sizes. The membrane 16 can be made of any of a variety of materials suitable for use in dialysis. In particular, the membrane 16 may be a semi-permeable membrane which allows sufficiently small molecules to pass therethrough, but blocks larger molecules from passing therethrough. In one embodiment, the membrane 16 is made of regenerated cellulose.

In order to assemble the dialysis device 10, the inner member 12, membrane 16 and outer member 14 are arranged in the configuration shown in FIG. 1, such that the membrane 16 is positioned between the coaxially aligned inner 12 and outer 14 members. The inner member 12 is then slid into the outer member 14, with the membrane 16 positioned between. When the inner member 12 is inserted to a sufficient depth, the flange 18 of the inner member 12 engages the lip 22 of the outer member 14 to ensure that the inner member 12 is inserted to the correct depth.

In one embodiment, the outer member 14 includes a groove (not shown) on its inner surface positioned immediately above the lip 22. When the inner member 12 is inserted into the outer member 14, the user experiences a slight resistance as the flange 18 approaches the groove until, with sufficient applied force, the flange 18 snaps into place. The groove and snap-fit configuration of the dialysis device 10 is optional and may not necessarily be utilized.

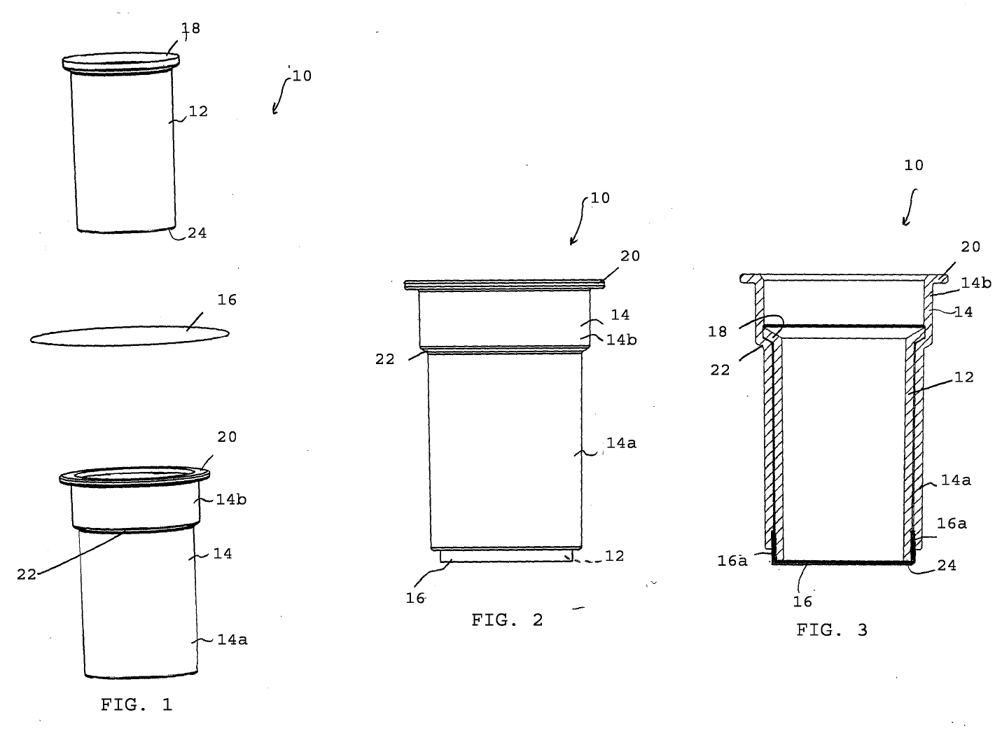

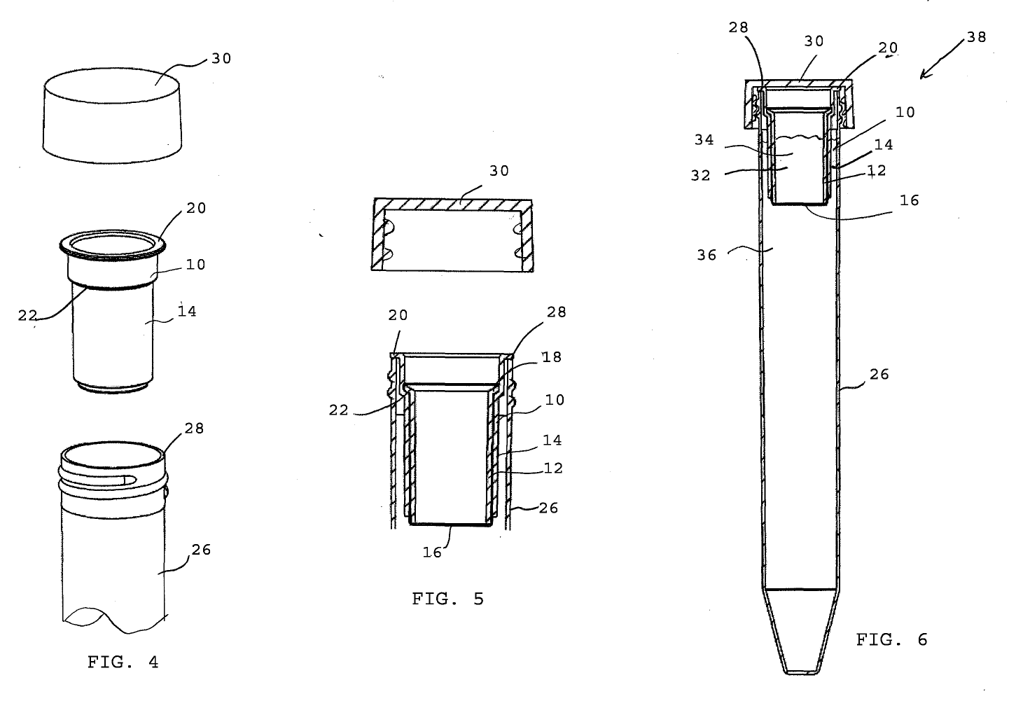

When the dialysis device 10 is properly assembled, as shown in FIGS. 2 and 3, the membrane 16 spans and extends across the open lower end of the inner member 12. In addition, radially outer portions 16a of the membrane 16 (FIG. 3) are folded upwardly and trapped between the inner 12 and outer 14 members. The outer radius of the inner member 12 may be shaped to closely correspond to the inner radius of the lower portion 14a of the outer member 14 such that the membrane 16 is trapped between in a secure and airtight or watertight manner.

When the dialysis device 10 is assembled, the inner member 12 protrudes at least slightly axially beyond the bottom of the outer member 14 to ensure that the membrane 16 is exposed to the buffer fluid, as described in greater detail below. In one embodiment, the bottom edge 24 of the inner member 12 is curved, tapered or beveled to minimize tearing or rupturing of the membrane 16 that is stretched thereacross. Further details relating to the dialysis device 10 are disclosed in U.S. Pat. No. 6,039,871, which is expressly incorporated by reference herein in its entirety.

As shown in FIGS. 4-6, the dialysis device 10 may be used in conjunction with a tube or vessel 26, such as a common tube used in conjunction with centrifuges, for reagents, for analysis, etc. The tube 26 can have any of a variety of shapes, but in the illustrated embodiment is generally cylindrical with a conical bottom tip. The dialysis device 10 is configured to be positioned in the tube 26 such that the flange 20 of the outer member 14 engages the upper lip 28 of the tube 20 to limit the insertion of the dialysis device 10 into the tube 26, and to locate the dialysis device 10 at the desired depth in the tube 26.

The system/tube may include a cap 30, such as a screw cap, which is threadably engageable with the outer surface of the tube 26. In this manner, when the cap 30 is threaded onto the tube 26, the cap 30 seals the tube 26. When the cap 30 is threaded down, the under side of the cap 30 engages the top of the flange 20, thereby forming a sealed engagement therewith, and pressing the flange 20 into sealing engagement upper lip 28 of the tube 26. The engagement of the cap 30 with the flange 20 forms a watertight seal for both the inner cavity 34 of the dialysis device 10 and the inner volume/cavity of the tube 26. The seal allows liquids in both cavities to communicate only through the membrane 16 and prevents accidental leakage, evaporation or contamination of the sample 32 positioned in the dialysis device 10. Thus, in one embodiment the flange 20 is shaped to have generally the same shape as the upper lip 28.

In use, a sample 32 (FIG. 6) containing small molecules which are desired to be removed is placed in the inner cavity 34 of the dialysis device 10/inner member 12 such as by a pipette or the like. A buffer solution or dialysate fluid 36 (i.e. containing a relatively low concentration of small molecules) is positioned in the tube 26. The dialysis device 10 is then inserted into the tube 26 such that the membrane 16 is submerged below the fluid level of the buffer 36, as shown in FIG. 6. Because the sample 32 is in contact with the membrane 16, and the membrane 16 is, in turn, in contact with the buffer 36, dialysis occurs across the membrane 16 as the smaller molecules of the sample 32 diffuse across the semi-permeable membrane 16 into the buffer solution 36. The dialysis device 10 is not floated or suspended in the buffer solution 16, and does not share buffer solution 16 with other dialysis devices 10, as in some other systems.

In one embodiment the buffer 36 has a volume of between about 15 and about 100 times the volume of the sample 32. This ratio of volumes helps to ensure that sufficient amounts of the small molecules are removed from the sample 32. In one embodiment, after a few hours of dialysis, the sample 32 may show at least a 90% reduction in small molecules. If desired, the dialysis procedure can be enhanced by removing the buffer solution 36 and replacing with a fresh buffer 36. Replacing the buffer 36 in this manner, and allowing sufficient time for dialysis, may, in one embodiment, allow well over 99% of the targeted small molecules to be removed from the sample 32. In one embodiment, the sample 32 has a volume of between about 0.2 and about 1 milliliters, and in one embodiment has a volume of between about 1 and about 4 milliliters. In one embodiment the buffer 36 has a volume of at least about 40 milliliters.

The dialysis system 38 shown in FIG. 6 provides a compact, self-contained, fluid-tight system. The buffer 36 and sample 32 are each contained in a closed volume, which eliminates the possibility of any spills, evaporation or contamination. As noted above, the dialysis device 10 can be sealingly positioned in the tube 26 such that the buffer 36 is prevented from passing past the flange 28 to the top side of the dialysis device 10. In this manner, the sealed system 38 of FIG. 6 can be angled or tilted on its side or inverted without contaminating the dialysis device 10/sample 32. A number of the sealed tubes 26 shown in FIG. 6 can be stacked and arranged in any manner to save space on a laboratory bench. The system 38 also uses tubes 26 which can be used in conjunction with commonly available storage racks, incubators or shakers which can be expected to be available and on hand in a variety of laboratory settings, such that the system does not require specialized equipment.

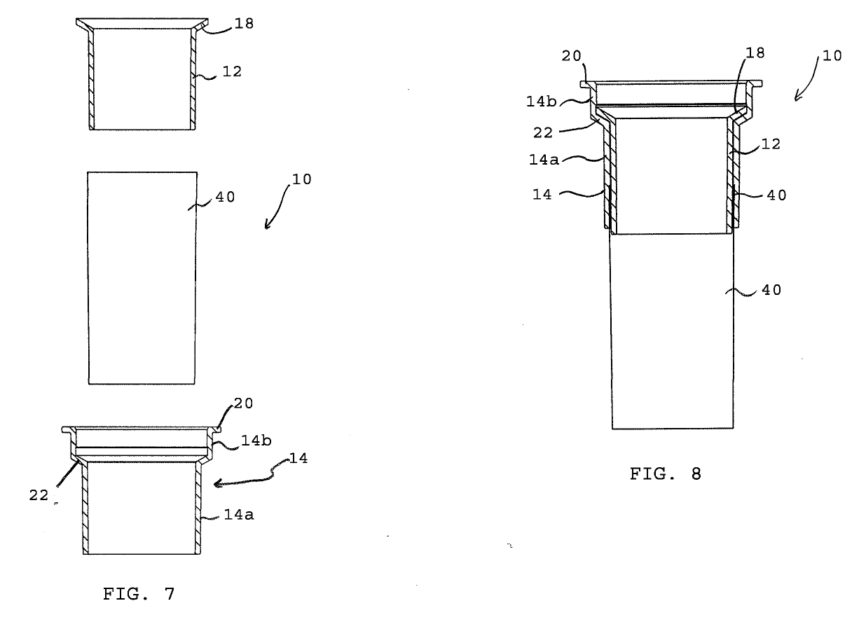

The dialysis device can also take other forms, e.g., as shown in FIGS. 7 and 8. In that embodiment, the dialysis device 10′ is similar to the dialysis device 10 shown in FIGS. 1-6, but the membrane 16 is replaced with a tube 40. The tube 40 can be made of the same materials as those described above for the membrane 16, including regenerated cellulose. The tube 40 may have an open top end to allow the sample 32 to be placed in it. The bottom end of the tube 40 may be plugged, e.g., with a non-porous material or a semipermeable membrane. The dialysis device 10′ can be placed into a tube 26 and provide the same functionality and advantages as the system 38 previously described. The tube 40 can also be replaced with membrane materials of various other shapes, such as a sack shape or the like.

Although the invention is shown and described with respect to certain embodiments, it should be clear that modifications and variations will be apparent to those skilled in the art upon reading the specification, and the present invention includes all such modifications and variations.

What is claimed is:

1. A dialysis system comprising
a generally sealed vessel configured to receive a buffer; and
a dialysis device positioned in the generally sealed vessel, wherein the dialysis device includes an inner member and an outer member trapping a dialysis membrane therebetween, and wherein the dialysis device is configured to receive a sample to enable dialysis of the sample with respect to the buffer across the membrane.

2. The system of claim 1 wherein the dialysis device sealingly engages the vessel such that any buffer in the vessel is generally fluidly isolated from any sample in the dialysis device except by dialysis through the membrane.

3. The system of claim 1 wherein the dialysis device sealingly engages the vessel such that fluid in the vessel on one side of the dialysis device is generally prevented from passing to the other side of the dialysis device except by dialysis through the membrane.

4. The system of claim 1 wherein the inner member is slidably and coaxially received in the outer member.

5. The system of claim 4 wherein the inner member and the outer members are both cylindrical, and wherein the inner member defines an inner volume configured to receive the sample.

6. The system of claim 1 further comprising a buffer received in the vessel and a sample received in the dialysis device, and wherein the buffer and the sample are both in contact with the membrane.

7. The system of claim 6 wherein the buffer has a volume between about 15 and about 100 times larger than the volume of the sample.

8. The system of claim 6 wherein the buffer has a volume of at least about 40 milliliters and the sample has a volume of between about 1 and about 4 milliliters.

9. The system of claim 1 wherein the vessel includes a lip at or adjacent to an upper end, and wherein the dialysis device includes a flange that engages the lip to limit the insertion of the dialysis device into the vessel, and wherein the lip and the flange form a seal therebetween.

10. The system of claim 9 further comprising a cap that threadably engages the vessel and presses the flange into sealing contact with the lip.

11. A dialysis system comprising a generally closed device configured to receive both a buffer and a dialysis chamber, where positioning the dialysis chamber in the device seals the device; the device being configured to receive a sample to enable dialysis of the sample with respect to the buffer across the membrane.

12. The system of claim 11 wherein the dialysis chamber sealingly engages the device such that buffer is generally fluidly isolated from sample in the dialysis chamber.

13. A dialysis method comprising the steps of
placing a buffer in a vessel;
accessing a dialysis device including an inner member and an outer member trapping a dialysis membrane therebetween;
placing a sample in the dialysis device;
placing the dialysis device into the vessel; and
sealing the vessel.

14. The method of claim 13 wherein the dialysis device sealingly engages the vessel such that the buffer in the vessel is generally fluidly isolated from the sample in the dialysis device except by dialysis through the membrane.

15. The method of claim 13 wherein the first placing step including placing the sample in the dialysis device such that the sample is in contact with the membrane, and wherein the second placing step includes placing the dialysis device into the vessel such that the membrane is in contact with the buffer to thereby enable dialysis of the sample.

16. The method of claim 13 further comprising the step of removing the buffer from the vessel and replacing the buffer with a new buffer to enable further dialysis of the sample.

17. The method of claim 13 further comprising the step of forming the dialysis device by accessing the inner member, accessing the outer member, and slidably inserting the inner member into the outer member with the membrane therebetween.

18. The method of claim 13 wherein the vessel includes a lip at or adjacent to an upper end thereof, and wherein the dialysis device includes a flange, and wherein the second placing step includes causing the flange to engage the lip to enable a seal to be formed therebetween.

19. The method of claim 18 wherein the sealing step includes coupling the cap to the vessel such that the cap presses the flange of the dialysis device into sealing contact with the lip.

20. The method of claim 19 wherein the cap is threadably coupled to the vessel.
